(19) United States
(12) Patent Application Publication
(10) Pub. No.: US 2013/0149049 A1
(43) Pub. Date: Jun. 13, 2013

(54) BLIND RIVET DRAWING MANDREL REMOVAL DEVICE

(71) Applicant: GESIPA BLINDNIETTECHNIK GMBH, Moerfelden-Walldorf (DE)

(72) Inventor: Hubertus KLEIN, Moerfelden-Walldorf (DE)

(73) Assignee: GESIPA BLINDNIETTECHNIK GMBH, Moerfelden-Walldorf (DE)

(21) Appl. No.: 13/679,429

(22) Filed: Nov. 16, 2012

(30) Foreign Application Priority Data
Dec. 9, 2011 (DE) 10 2011 120 605.5

(51) Int. Cl. B65G 51/18

(52) U.S. Cl. CPC B65G 51/18
USPC 406/152

(57) ABSTRACT

Blind rivet drawing mandrel removal device and method for removing drawing mandrel of a blind rivet. The device includes a transport channel having an inlet opening and at least one blow-in opening, a blow-out path being connected to the transport channel at a predetermined distance downstream of the blow-in opening, and a switchover device structured and arranged to switch over between a suctioning of a drawing mandrel and a blowing of the drawing mandrel.

### CROSS-REFERENCE TO RELATED APPLICATIONS

The present application claims priority under 35 U.S.C. §119(a) of German Patent Application No. 10 2011 120 605.5 filed Dec. 9, 2011, the disclosure of which is expressly incorporated by reference herein in its entirety.

### BACKGROUND OF THE INVENTION

1. Field of the Invention

The invention relates to a blind rivet drawing mandrel removal device with a transport channel. The transport channel includes an inlet opening and at least one blow-in opening and is connected to a blow-out path at a predetermined distance downstream of the blow-in opening.

2. Discussion of Background Information

During the setting of a blind rivet, the blind rivet is guided through a corresponding opening into an object until the so-called “set head” bears against the object. When this position is reached, the drawing mandrel of the blind rivet is drawn out of the blind rivet. The drawing mandrel thereby forms the so-called “closure head” on the other side of the object (or, if several objects are to be connected to one another, on the other side of the outermost object). When a certain tensile force has been reached, the drawing mandrel is torn off.

In particular, with automated blind rivet setting operations, the drawing mandrel must be disposed of so that it is no longer disruptively in the way of the next blind rivet setting operations.

It is known for this purpose to use a suctioning. With a suctioning of this type, an airflow is guided into the transport channel at a small distance behind the inlet opening. This airflow has the possibility of exiting from the transport channel again shortly after the introduction. This produces a vacuum, which accelerates the torn-off drawing mandrel along the transport channel. The acceleration is generally so large that the drawing mandrel can cover a certain distance inside the transport channel. When the position towards which the drawing mandrel must be disposed of is longer, several such suction devices must be arranged along the transport channel. This makes the suctioning-off of the drawing mandrels complex in the case of greater distances.

### SUMMARY OF THE EMBODIMENTS

Embodiments of the invention simplifies the removal of torn-off drawing mandrels of blind rivets.

According to embodiments, a blind rivet drawing mandrel removal device of the type mentioned at the outset includes a switchover device that switches over between a suctioning of a drawing mandrel and a blowing of the drawing mandrel.

The drawing mandrel is initially suctioned. To this end, the “suction device” can be arranged at a distance of, e.g., approximately 30 cm behind the setting tool, i.e., behind the “rivet gun.” The suction device with the above described blow-in opening is then able to generate a vacuum with which the drawing mandrel can be suctioned. As soon as the drawing mandrel has covered a certain distance in the transport channel, the switchover direction switches to “blow.” The drawing mandrel is then no longer further transported by suction air or its own inertia. Instead, it is further transported by an airflow. While air is used herein as an example, it is understood that other gases can also be used to transport the drawing mandrel without departing from the spirit and scope of the invention. With a blowing of this type, a much better transport power can be achieved, i.e., the drawing mandrel can be conveyed over a longer distance with the same expenditure of air. Accordingly, in many cases intermediate stations can be avoided in which a transport power again must be supplied. In many cases, the blown air is sufficient to blow the rivet to the end of the transport channel at which the actual disposal can take place. If the transport channel is too long, a further blowing station can naturally be provided inside the length of the transport channel.

It may be preferable for the blow-out path to have a changeable blow-out resistance. When the removal device is operated in a suction operation, the blow-out path should have a blow-out resistance that is as low as possible so that the air can easily escape from the transport channel to the outside. In this case, a relatively high vacuum is generated which can be used to suction the drawing mandrel. When the blow-out resistance then is throttled, depending on the throttle resistance, a part or even the whole of the air blown into the transport channel is used to further transport the drawing mandrel by blowing. The transport speed and also the transport distance can be controlled by the blow-out resistance within certain limits.

Preferably, the blow-out path can be closed by a valve element. When the blow-out path is closed, air can no longer escape through the blow-out path. Instead, all of the air must flow through the transport channel and can thereby carry along the drawing mandrel.

It may be preferable that the transport channel is connected to the blow-out path via a blow-out opening and the valve element closes the blow-out opening. This is a mechanically relatively simple embodiment. In this case, the blow-out path does not need to be guided into a closed pipe system, but embodiments can be selected more or less as desired. However, a defined position is available at which the blow-out path can be interrupted.

Preferably, the valve element is displaceable parallel to a flow direction through the transport channel. The valve element is thus embodied as a slider. A slider of this type can be moved easily. The movement direction is thereby directed approximately perpendicular to the blow-out direction of the air from the transport channel, so that the closing as well as the opening can be carried out under the same pressure conditions.

It is preferable hereby that the valve element surrounds the transport channel in an annular manner. The transport channel then serves as a holder for the valve element. The valve element is simply embodied or formed as a ring that is pushed onto the transport channel outside. When the transport channel has a circular outer circumference, the valve element can also have a circular opening. The tolerances can be kept small. An absolutely tight closure of the blow-out path is generally not necessary. Smaller leaks are definitely permitted.

Preferably, the transport channel has a throttle valve upstream of the blow-in opening. This throttle valve further improves the effect of the blowing. The throttle valve prevents the air blown into the transport channel from escaping “backwards,” as it were, out of the transport channel. The transport channel is thus interrupted between the inlet opening, through which the drawing mandrel enters, and the blow-in opening, through which the conveyor air enters. The closure does not need to be absolutely tight here, either. The flow resistance must be increased only so far that appreciable airflows can no longer escape.

Preferably, a control device is provided, which actuates the valve element. This control device can then work in a different way. Basically, only a controlled drive is necessary. The control device, of course, can also actuate the throttle valve.

It is preferable that the control device is connected to a sensor that detects a passage of a drawing mandrel. In this case, the valve element and optionally also the throttle device is actuated, and preferably always actuated, when a drawing mandrel has passed the sensor. The position of the sensor can thereby be freely selected within broad limits if the movement speed of the drawing mandrel is additionally considered. Basically, any position downstream of the blow-in opening is possible, which is not too far removed from the blow-out opening. Preferably, the sensor is arranged downstream just behind the blow-out opening.

In an alternative embodiment, it can be provided that the control device is connected to a control of a blind rivet setting device. The control device then “knows” when a setting operation has taken place and when accordingly a drawing mandrel is to be expected. The control device can then wait a predetermined time after the setting operation, which is sufficient to suction the drawing mandrel past the blow-in opening, before the valve element closes or throttles the blow-out path.

Preferably, the transport channel is arranged in a chamber of a housing. The chamber is connected to a compressed gas connection. This is a simple way of introducing the compressed gas, in particular air, into the transport channel. For this purpose, the transport channel has several blow-in openings distributed in the circumferential direction, which blow-in openings ensure that the drawing mandrel is not pressed in a one-sided manner against an inner wall of the transport channel. The distribution of the compressed gas is thereby carried out in the chamber of the housing.

Preferably, the blow-in opening encloses an acute angle with a center axis of the transport channel in the region of the blow-in opening. The air that is blown into the transport channel is thus immediately given the “correct” direction to the outlet of the transport channel. The suction effect and the blowing effect are thereby further improved.

Embodiments of the invention are directed to a blind rivet drawing mandrel removal device. The device includes a transport channel having an inlet opening and at least one blow-in opening, a blow-out path being connected to the transport channel at a predetermined distance downstream of the blow-in opening, and a switchover device structured and arranged to switch over between a suctioning of a drawing mandrel and a blowing of the drawing mandrel.

According to embodiments, the blow-out path can have a changeable blow-out resistance. Further, the blow-out path may be closable by a valve element. The transport channel can be connected to the blow-out path via a blow-out opening and the valve element may be arranged to close the blow-out opening. Moreover, the valve element can be displaceable parallel to a flow direction through the transport channel. The valve element can surround the transport channel in an annular manner.

In accordance with embodiments of the invention, the transport channel may further have a throttle valve arranged upstream of the at least one blow-in opening.

According to other embodiments, the device can further include a control device structured and arranged to actuate the valve element. Further, a sensor can be structured and arranged to detect passage of a drawing mandrel, and the sensor can be coupled to the control device. The control device may be connectable to a control of a blind rivet setting device.

In still other embodiments, the device may include a housing with a chamber in which the transport channel is arranged at least in part; and a compressed gas connection can be connected to the chamber.

Moreover, the at least one blow-in opening can be oriented at an acute angle to a center axis of the transport channel.

Embodiments of the invention are directed to a method for removing a blind rivet drawing mandrel. The method includes creating a suction force to pull a drawing mandrel into a transport channel and switching the suction force to a blowing force to push the drawing mandrel further through the transport channel.

In accordance with embodiments, the suction force may be created by an air flow through at least one blow-in opening into the transport channel. Further, the air blown into the transport channel can be guided out along a blow-out path located at a predetermined distance downstream of the blow-in opening. The suction force can be switched to the blowing force by closing off the blow-out path. The suction force may be switched to the blowing force by closing a throttle valve upstream of the at least one blow-in opening.

According to other embodiments of the invention, before the switching, the method can further include determining whether the drawing mandrel has been pulled to a predetermined position.

Embodiments of the invention are directed to a blind rivet drawing mandrel removal device that include a transport channel having an inlet opening, at least one blow-in opening and an airflow output, an air chamber arranged to couple an air supply to the at least one blow-in opening, and a valve arranged to selectively open and close the airflow output to switch between a suctioning of a drawing mandrel and a blowing of the drawing mandrel.

In accordance with still yet other embodiments of the present invention, the at least one blow-in opening can extend through a wall defining the transport channel at an acute angle to a center axis of the transport channel.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 a diagrammatically illustrates a blind rivet drawing mandrel removal device in suction operation; and

FIG. 2 illustrates the device in blowing operation.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

A blind rivet drawing mandrel removal device 1 has a transport channel 2, which is embodied or formed, e.g., inside a pipe 3. Transport channel 2 has an inlet opening 4, through which a drawing mandrel 5 of a blind rivet, not shown in further detail, can enter transport channel 2. The entry can be connected to a disposal outlet of a blind rivet setting device, for example.

Pipe 3 is arranged in a housing 6 having a first chamber 7, which is connected to a compressed gas connection 8. Furthermore, the housing has a second chamber 9, which is connected to an outlet 10.

In the region of first chamber 7, pipe 3 has several blow-in openings 11 uniformly distributed in the circumferential direction. These blow-in openings 11 enclose an acute angle with a center axis of transport channel 2 likewise in the region of blow-in openings 11. When air is now blown in through compressed gas connection 8 into first chamber 7, this air, symbolized by arrows 12, flows in at the angle of blow-in openings 11 into transport channel 2 and there forms a flow, symbolized by arrows 13, which converges toward the axis of transport channel 2 and is directed away from inlet opening 4. This air flow creates a suction to pull drawing mandrel 5, as symbolized by arrows 14.

In order for the airflow to be able to develop a corresponding suction effect, it is important that the flow does not face any greater flow resistance. A flow resistance of this type could be formed, for example, by a quantity of air that is present in transport channel 2. For this reason, several blow-out openings 15 are provided in pipe 3 downstream of blow-in openings 11, which blow-out openings 15 open into second chamber 9. Second chamber 9 can blow out the air entering through blow-out openings 15 through outlet 10, which is not closed. Blow-out openings 15 together with chamber 9 and outlet 10 form a blow-out path.

Due to the suctioning with the aid of the airflow, drawing mandrel 5 is accelerated to a certain speed. Due to its mass inertia, drawing mandrel 5 can then still move over a certain distance in transport channel 2. However, since drawing mandrel 5 during this movement is no longer exposed to any further drive and a friction between drawing mandrel 5 and pipe 3 is inevitable, the distance that drawing mandrel 5 can still cover in transport channel 2 is limited. A new suction device would be necessary after a certain distance of 1 to 3 m, for example. However, providing this added suctioning makes the removal of the drawing mandrels 5 relatively complex.

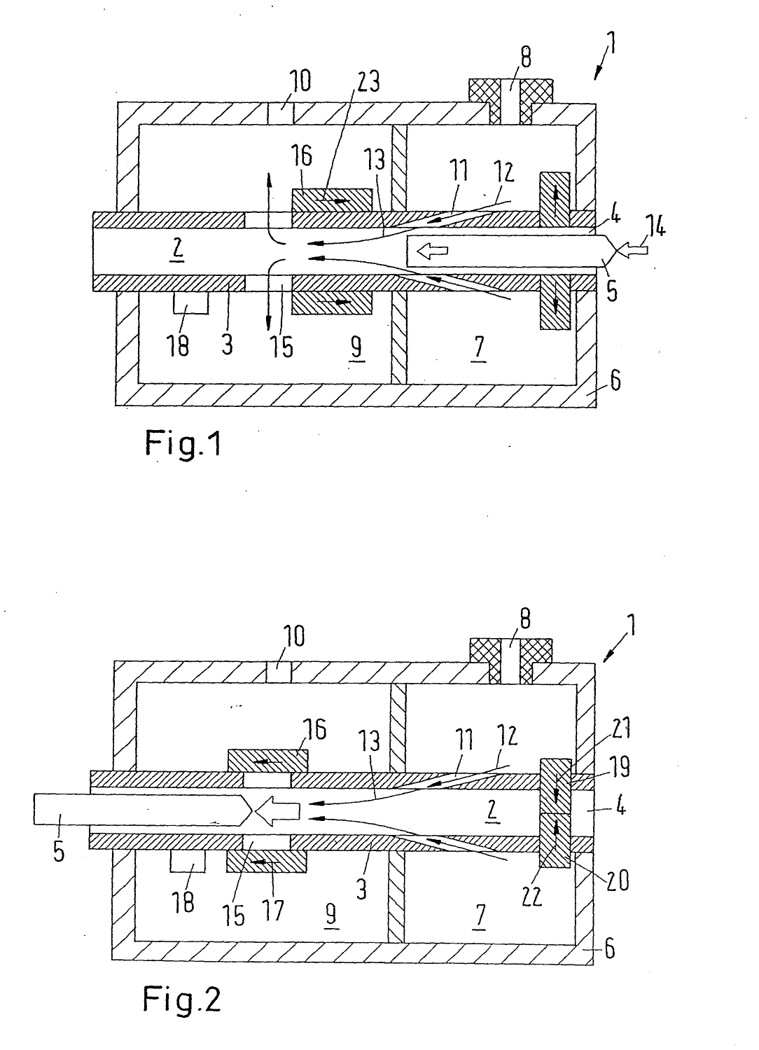

FIG. 2 shows an option for designing this removal in a different way. The same elements are provided with the same reference numbers as in FIG. 1.

A valve element 16 is provided, which surrounds pipe 3 in an annular manner and can be displaced in the direction of an arrow 17 parallel to the longitudinal extension of pipe 3. A drive necessary for the movement is not shown for reasons of clarity. A control device that actuates the drive is likewise not shown for reasons of clarity.

When valve element 16 has been moved from the position shown in FIG. 1 into the position shown in FIG. 2, blow-out openings 15 in the wall of pipe 3 are closed and thus also the blow-out path through second chamber 9 and outlet 10. The air blown in through blow-in openings 11 now drives drawing mandrel 5 in front of it and blows it through transport channel 2. Drawing mandrel 5 is thus subjected to an additional drive force over a much larger part of its movement, namely the pressure that is applied through airflow 13, so that it can also cover much larger distances. In many cases the drive force by the airflow 13 is sufficient to transport drawing mandrel 5 over 5 to 10 m to the desired disposal location.

In order to control the movement of valve element 16, a sensor 18 can be provided on pipe 3. Sensor 18 detects the passage of drawing mandrel 5. As soon as the sensor has established that drawing mandrel 5 is passing it, it triggers the displacement of valve element 16 and thus the closure of the blow-out path.

Naturally, sensor 18 can also be arranged at a different position. When it is arranged upstream of the position shown, the movement speed of the drawing mandrel in transport channel 2 must also be taken into consideration in order to cause the closure of the blow-out path at the correct time.

Alternatively thereto, the control device can also be connected to the control of a blind rivet device. Blow-out opening 15 can be closed a predetermined time after the setting of a blind rivet in order to cause the blowing of drawing mandrel 5.

An additional measure to further improve the blowing out lies in actuating a throttle valve that closes transport channel 2 between blow-in openings 11 and inlet opening 4. The throttle valve is here shown diagrammatically by two plates 19, 20, which can be moved radially towards one another in the direction of arrows 21, 22. When the two plates 19, 20 bear against one another, as shown in FIG. 2, an exit of air through the inlet opening 4 is virtually ruled out. However, smaller leaks are definitely permissible.

When drawing mandrel 5 has been transported far enough, which can be ensured for example by waiting for a predetermined period of time, valve element 16 is moved in the direction of an arrow 23, that is, opposite to the direction of arrow 17, so that blow-out opening 15 is opened again. At the same time, the throttle valve with plates 19, 20 is opened so that inlet opening 4 is free again and transport channel 2 is available for a new suctioning of a drawing mandrel 5.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A blind rivet drawing mandrel removal device comprising:
a transport channel having an inlet opening and at least one blow-in opening;
a blow-out path being connected to the transport channel at a predetermined distance downstream of the blow-in opening; and
a switchover device structured and arranged to switch over between a suctioning of a drawing mandrel and a blowing of the drawing mandrel.

2. The blind rivet drawing mandrel removal device according to claim 1, wherein the blow-out path has a changeable blow-out resistance.

3. The blind rivet drawing mandrel removal device according to claim 2, wherein the blow-out path is closable by a valve element.

4. The blind rivet drawing mandrel removal device according to claim 3, wherein the transport channel is connected to the blow-out path via a blow-out opening and the valve element is arranged to close the blow-out opening.

5. The blind rivet drawing mandrel removal device according to claim 3, wherein the valve element is displaceable parallel to a flow direction through the transport channel.

6. The blind rivet drawing mandrel removal device according to claim 5, wherein the valve element surrounds the transport channel in an annular manner.

7. The blind rivet drawing mandrel removal device according to claim 1, wherein the transport channel further having a throttle valve arranged upstream of the at least one blow-in opening.

8. The blind rivet drawing mandrel removal device according to claim 3, further comprising a control device structured and arranged to actuate the valve element.

9. The blind rivet drawing mandrel removal device according to claim 8, further comprising a sensor structured and arranged to detect passage of a drawing mandrel, the sensor being coupled to the control device.

10. The blind rivet drawing mandrel removal device according to claim 8, wherein the control device is connectable to a control of a blind rivet setting device.

11. The blind rivet drawing mandrel removal device according to claim 1, further comprising a housing with a chamber in which the transport channel is arranged at least in part; and a compressed gas connection connected to the chamber.

12. The blind rivet drawing mandrel removal device according to claim 1, wherein the at least one blow-in opening is oriented at an acute angle to a center axis of the transport channel.

13. A method for removing a blind rivet drawing mandrel, comprising:
creating a suction force to pull a drawing mandrel into a transport channel; and
switching the suction force to a blowing force to push the drawing mandrel further through the transport channel.

14. The method according to claim 13, wherein the suction force is created by an air flow through at least one blow-in opening into the transport channel.

15. The method according to claim 14, wherein the air blown into the transport channel is guided out along a blow-out path located at a predetermined distance downstream of the blow-in opening.

16. The method according to claim 15, wherein the suction force is switched to the blowing force by closing off the blow-out path.

17. The method according to claim 15, wherein the suction force is switched to the blowing force by closing a throttle valve upstream of the at least one blow-in opening.

18. The method according to claim 13, wherein, before the switching, the method further comprises determining whether the drawing mandrel has been pulled to a predetermined position.

19. A blind rivet drawing mandrel removal device comprising:
a transport channel having an inlet opening, at least one blow-in opening and an airflow output;
an air chamber arranged to couple an air supply to the at least one blow-in opening; and
a valve arranged to selectively open and close the airflow output to switch between a suctioning of a drawing mandrel and a blowing of the drawing mandrel.

20. The blind rivet drawing mandrel removal device according to claim 19, wherein the at least one blow-in opening extends through a wall defining the transport channel at an acute angle to a center axis of the transport channel.
